(19) United States
(12) Patent Application Publication
(10) Pub. No.: US 2024/0010289 A1
(43) Pub. Date: Jan. 11, 2024

(54) STORAGE APPARATUS

(71) Applicant: ABUS August Bremicker Söhne KG, Wetter-Volmarstein (DE)

(72) Inventors: Stefan HEINEMANN, Wetter (DE); Wolfgang Tobias BREDDERMANN, Oberhausen (DE)

(21) Appl. No.: 18/213,932

(22) Filed: Jun. 26, 2023

(30) Foreign Application Priority Data
Jul. 8, 2022 (DE) 102022117102.7

(51) Int. Cl. B62J 9/30; B62J 9/20

(52) U.S. Cl. CPC B62J 9/30; B62J 9/20

(57) ABSTRACT

The present invention relates to a storage apparatus for mounting to a two-wheeler. In addition to a container and a lid, the storage apparatus includes a closure which is configured to selectively occupy one of three states in a closed position of the lid: a releasing state in which the closure releases the lid for movement to the open position; a securing state in which the closure secures the lid in the closed position; and a locking state in which the closure locks the lid in the closed position. An identification means is associated with the closure, and the closure is configured such that it may be brought from the securing state to the releasing state without using the associated identification means, but may only be brought from the locking state to the releasing state by using the associated identification means.

### CROSS-REFERENCE TO RELATED APPLICATION

This application claims the benefit and priority of German Patent Application No. DE 102022117102.7 filed on Jul. 8, 2022. The entire disclosure of the above application is incorporated herein by reference.

### FIELD

The present invention relates to a storage apparatus for mounting to a two-wheeler and to a two-wheeler equipped with such a storage apparatus.

### BACKGROUND OF THE INVENTION

Such a storage apparatus is used for facilitating the transport of objects with the two-wheeler and/or for the safe storage of objects during a standstill of the two-wheeler. For this purpose, conventional storage apparatuses comprise a container with an opening that opens into a storage space of the container. Through said opening, a user may access the objects housed in the storage space. For closing this opening, the storage apparatus comprises a lid which is movable between an open position and a closed position. In the open position, the storage space of the container is accessible. In the closed position, the lid closes the opening of the container. Furthermore, the storage apparatus may comprise a mounting device for mounting the container to the two-wheeler.

With such storage apparatuses, there is a desire to be able to secure the lid against inadvertent opening, in particular while the two-wheeler is being ridden, and also against unauthorized access, in particular when the two-wheeler is at a standstill, without restricting or obstructing the user's own access to the storage space more than is necessary. In particular, convenient handling should be possible, also when, for example, for during just a brief standstill of the two-wheeler an anti-theft device is not necessary.

### SUMMARY OF THE INVENTION

Against this background, it is an object of the present invention to provide a storage apparatus which enables a particularly flexible and yet reliable securing of the lid in its closed position.

This object is achieved by a storage apparatus having the features of claim 1. Advantageous further embodiments of such a storage apparatus are to be taken from the dependent claims.

A storage apparatus according to the invention comprises, in addition to the above-mentioned features, a closure which is configured to selectively adopt a releasing state, a securing state and a locking state in the closed position of the lid. In the releasing state, the closure releases the lid for movement to the open position. In the securing state, the closure secures the lid in the closed position against movement in the direction of the open position. For this purpose, a latch for example, may be provided which may be moved by a simple manual actuation in the releasing state and the securing state. In the locking state, the closure or a latch locks the lid in the closed position. Thus, also in the locking state, the closure secures the lid in the closed position against movement in the direction of the open position, whereby, however, a locking takes place that cannot be undone by a mere simple manual operation. Instead, an identification means necessary for the unlocking is associated with the closure (mechanical or electronic identification means). The closure is configured such that it can be brought from the securing state to the releasing state without using the associated identification means, but can only be brought from the locking state to the releasing state by using the associated identification means.

In other words, the closure is configured such that it can be brought from the releasing state to the securing state, and vice versa, for an easy securing of the lid against independent opening. In this case, use of the associated identification means is not necessary. However, if a locking of the lid is desired for the purpose of theft protection, for example to protect the storage space of the container against unauthorized access when the two-wheeler is parked, the closure may be brought into the locking state. From here, the closure can be unlocked and brought back to the releasing state or the securing state only by using the associated identification means. In doing so, a user may freely choose whether he wants to move the closure from the releasing state to the securing state only or to the locking state, in order to keep the lid in the closed position. In particular, the user does not require a separate additional locking device for locking the lid, which is to be provided in addition to a closure having only the releasing state and the securing state. Conversely, a user does not necessarily always require the associated identification means to open the lid, provided only the securing state is selected to secure the lid in the closed position.

In some embodiments, the mounting device provided is configured for mounting the container in a theft-proof manner to the two-wheeler such that the container may be removed in a non-destructive manner from the two-wheeler only when the lid is open and/or only with the aid of a tool or an identification means. The identification means for releasing the mounting device may, for example, be the associated identification means already mentioned above or another identification means (mechanical or electronic).

Such a mounting device for a theft-proof mounting thus differs from interchangeable holders, such as those known, for example for shopping baskets, which may be mounted to the handlebars of a two-wheeler. This can prevent the storage apparatus from being removed from the two-wheeler by a third party in an unauthorized or inconspicuous manner.

In some embodiments, the mounting device comprises at least one holder which is configured to cooperate with a counterpart of the two-wheeler. As a result, a reliable mechanical fit of the storage apparatus to the two-wheeler may be brought about.

Additionally or alternatively thereto, the mounting device may comprise at least one flat or angled tab having a mounting opening through which a mounting means, for example a clamp, a screw or a rivet, may be led in order to mount the container to the two-wheeler.

Additionally or alternatively thereto, the mounting device may comprise a locking mechanism that can be unlocked only from the storage space of the container, and/or comprise a lock which is configured to secure the container to the two-wheeler. This ensures that the container may only be removed non-destructively from the two-wheeler by the authorized user.

These variants are particularly easy to implement and are especially suitable for mounting the container or storage apparatus adequately and securely.

The closure may comprise a mechanical or electronic locking cylinder. A mechanical locking cylinder may have a key as an identification means. The mechanical locking cylinder may comprise a cylinder core rotatably mounted in the cylinder housing which may comprise a drive section, in particular for actuating a catch for a latch of the closure, as will be explained in the following. The (mechanical) key may in particular be introduced into a key passage of the cylinder core. An electronic locking cylinder may have a code as an identification means which is transmitted wirelessly, in particular as a radio signal (e.g. Bluetooth, NFC), for example from a smartphone to a radio receiver of the closure. The closure may comprise an electronic evaluation and control device for this purpose. In particular, the electronic locking cylinder may comprise an electric motor or a solenoid as an actuator, for example in order to drive a latch of the closure directly or to drive (rotationally or linearly) a catch (e.g. a pin) for a latch.

In some embodiments, the closure comprises a locking cylinder which is oriented obliquely with respect to an extension plane of the lid, for example at an angle of approximately 45 degrees. For example, the locking cylinder, and thus an insertion opening for the associated key as an identification means, may project obliquely from a housing of the closure with respect to a in particular substantially horizontal cover surface of the lid. This can prevent that rainwater collects on the locking cylinder without being able to run off, while at the same time allowing comfortable manual operation of the locking cylinder by means of the associated key without this being hindered by the cover surface of the lid.

In some embodiments, the closure comprises a manually operable latch, wherein the latch can be moved along an actuation direction selectively to a securing position in order to bring the closure into the securing state, or beyond the securing position to a locking position in order to bring the closure into the locking state. Such an embodiment, in which the latch is moved from a releasing position to beyond a securing position to a locking position, is particularly easy to implement and intuitive to operate. The terms releasing position, securing position and locking position, as used here and in the following, include both translational and rotational relative positions or orientations.

In some embodiments, as explained above, the closure comprises a locking cylinder (mechanical or electronic). The locking cylinder may be configured such that in a locked position, the locking cylinder locks the latch in the locking position (directly or indirectly, e.g. via a catch), or selectively, in an unlocked position, the locking cylinder releases the latch for movement from the locking position in the direction of the securing position. In this case, the locking cylinder can be brought from the locked position into the unlocked position only by using the associated identification means. Such a design enables a particularly easy operation and a reliable functionality.

In some embodiments, the closure includes a biased catch which is configured to automatically engage with the latch as a result of movement of the latch from the securing position to the locking position, so as to lock the latch in the locking position. In this case, the catch can be disengaged from the latch by bringing the locking cylinder into the unlocked position. Such an automatic engagement further facilitates operation and avoids operation errors.

Alternatively, the closure comprises a catch which is configured to engage with the latch by manual actuation, so as to lock the latch in the locking position. In this case, the catch can be disengaged from the latch by bringing the locking cylinder into the unlocked position. Such an embodiment is structurally simpler to implement and may allow a particularly robust design.

In some embodiments, the latch may be movable in a straight line along the actuation direction. In some embodiments, in particular the latch may be operable in the manner of the ink cartridge of a retractable ballpoint pen to allow easy switching between the different latch positions. Such embodiments are comparatively simple and intuitive to operate.

Alternatively, the latch may be movable, for example, according to a circular path along the actuation direction. Such designs may be implemented in a particularly compact manner and are robust to carry out.

In some embodiments, the container is rigidly formed, in particular made of plastic and/or metal. A rigid configuration is particularly robust against any kind of external force influences, for example, in the event of a fall or an attempted unauthorized breaking open of the container.

Alternatively, the container may be configured to be at least partially flexible, in particular is made of a fabric, selectively with an additional structure and/or a rigid base. Such flexible designs are lightweight and less susceptible to impact.

In some embodiments, the lid is pivotally mounted to the container between its open position and its closed position. Such an embodiment allows for ease of handling when opening the lid.

In some embodiments, the closure comprises a handle. Such a handle may in particular be integrated into a housing of the closure and may facilitate the opening of the lid in the releasing state of the closure.

A further aspect of the present invention relates to a two-wheeler having a front axle and a rear axle, each of which has at least one wheel mounted thereon, and having a storage apparatus mounted to the two-wheeler which is in accordance to at least one of the previously described embodiments. Through such a combination, the advantages obtained by the storage apparatus according to the present invention may be utilized effectively.

In some embodiments, the two-wheeler is a bicycle, a motorcycle, an e-bike, a pedelec or a cargo bike.

In some embodiments, the two-wheeler has at least one additional wheel, which is provided in particular at the front axle or at the rear axle of the two-wheeler. In other words, the two-wheeler may also comprise more than two wheels, for example, as a trike or quad bike.

### DRAWINGS

The present invention is explained in the following merely by way of example with reference to the accompanying drawings.

FIG. 1 shows a partial perspective view of a storage apparatus according to an embodiment having a locking mechanism comprising an axially displaceable latch in the manner of a retractable ball point pen mechanism; and

FIG. 2 shows schematically the function of an exemplary alternative locking mechanism having a rotatable latch.

### DETAILED DESCRIPTION OF THE INVENTION

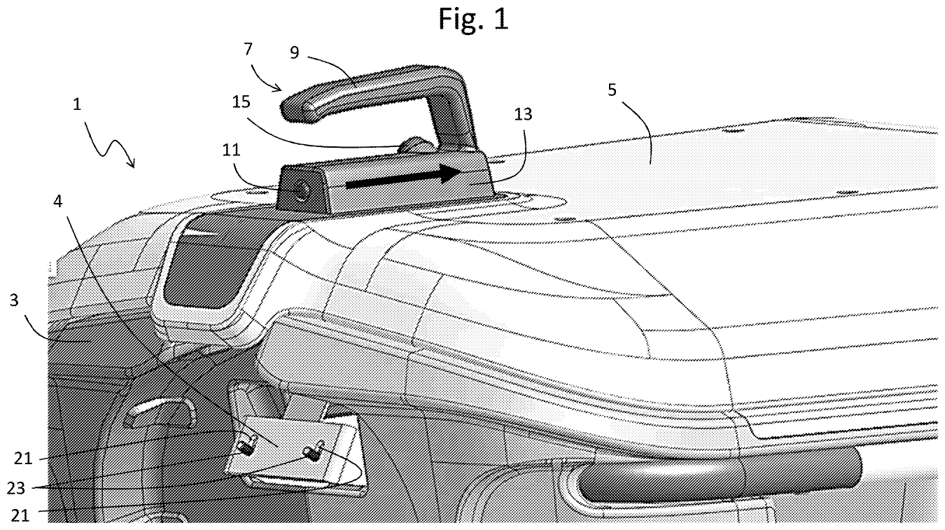

As shown in FIG. 1, a storage apparatus 1 comprises a container 3, a lid 5 and a closure 7. The container 3 includes an opening, not shown here, through which a storage space inside the container 3 may be accessed. The container 3 is mountable or mounted to a two-wheeler (not shown) via a mounting device 4 (described in more detail below). The opening of the container 3 is presently closed by the lid 5. The lid 5 is mounted to the container 3 via a hinge (not shown) and is pivotable between an open position, in which it exposes the opening of the container 3, and a closed position (see FIG. 1), in which it closes the opening.

In the embodiment example shown, the closure 7 is provided with a handle 9 for easy operation and serves to lock the lid 5 in its closed position, namely, to secure or lock it. In the shown embodiment example, the handle 9 is formed directly as a formation of a housing 13 of the closure 7. However, other embodiments are also possible, such as for example, having a separate handle 9 mounted to the housing 13 or a handle independent of the closure 7.

The closure 7 may occupy at least the following three different states. In a releasing state, the closure releases the movement of the lid 5 into its open position. In both a securing state and a locking state, the closure secures the lid 5 in its closed position, thus blocking the movement of the lid 5 into its open position.

The securing state and the locking state differ from each other in that an identification means (here: a mechanical key, not shown) associated with the closure 7 must be used in order to bring the closure 7 from the locking state into the releasing state. In contrast, it is possible to bring the closure 7 from its securing state into the releasing state without the use of the associated identification means. Consequently, the securing state serves to secure and release the lid 5 in its closed position in a particularly simple and trouble-free manner. The locking state serves for a particularly reliable securing of the lid 5 in its closed position and, in particular, also serves to prevent the theft of objects stored in the storage space of the container 3. However, in the locking state, the unlocking is also more complex for the authorized user, since he requires in particular the associated identification means for this purpose.

In the example shown, the closure 7 comprises a manually operable latch 11, which is movable (see the arrow in FIG. 1) in the longitudinal direction of the housing 13 of the closure 7 (i.e. along a corresponding actuation direction) from a releasing position, associated with the releasing state, to a securing position (shown here), associated with the securing state. In order to move the latch 11 to a locking position, associated with the locking state, the latch 11 is movable beyond the securing position further in the housing 13 (further along the arrow in FIG. 1).

The closure 7 shown furthermore comprises a locking cylinder 15 which can be brought into a locked position and an unlocked position. In the locked position, the locking cylinder 15 locks the latch against movement, in particular against movement from the locking position in the direction of the releasing position or the securing position. In the unlocked position, the locking cylinder 15 releases the movement of the latch 11 from its locking position. In this case, the locking cylinder 15 can only be moved from its locked position into its unlocked position using the associated key as identification means.

For the explained locking function, the closure 7 may include a biased catch (not shown here) which, for example, may be coupled in a driving manner to a drive section of a rotatable cylinder core of the locking cylinder 15. In response to a movement of the latch 11 from its securing position to its locking position, the catch may automatically engage with the latch 11 or engage in a locking recess of the latch 11, in order to lock the latch 11 in the locking position. For this purpose, it may be provided for example, that for a movement of the latch 11 from the securing position to the locking position, the catch is briefly pushed back against a spring load (in particular due to cooperating lead-in chamfers at the latch tip and at the catch), wherein the catch subsequently snaps into said locking recess of the latch 11. With the help of the associated key, the lock cylinder 15 may then be brought back into the unlocked position so as to release the catch from the latch 11 again and thereby release the latch 11. In particular, the drive section of the rotatable cylinder core of the locking cylinder 15 may retract the catch from said locking recess of the latch 11 against the spring load. In such an embodiment, the latch 11 may selectively also be biased so that the latch 11 automatically moves back towards the securing position after such a release or unlocking.

Alternatively, the closure 7 may include a catch (not shown) which, by active manual actuation, can be brought into engagement with the latch 11 in order to lock the latch 11 in its locking position. Also in this case, with the help of the associated key, the lock cylinder 15 may then be brought back again into the unlocked position in order to release the catch from the latch 11 and thereby release the latch 11.

For easier access to the locking cylinder 15, which is arranged at the housing 13 below the handle 9, the locking cylinder projects from the housing 13 of the closure 7 at an angle, in particular at an angle of approximately 45 degrees with respect to a substantially horizontal cover surface of the lid 5.

In the embodiment example shown in FIG. 1, the latch 11 is movable in a straight line along its actuation direction, i.e. axially along the longitudinal axis of the latch 11 and the housing 13 of the closure 7.

In particular, the latch 11 can be operated in the manner of the ink cartridge of a retractable ballpoint pen, as, for example, is shown and described in DE 101 01 767 A1. Specifically, the latch 11 is configured to engage when an engaging point, which defines the securing position of the latch 11, is exceeded once. If the latch 11 is subsequently moved again only slightly beyond this first engaging point and released, the latch 11 is moved past the securing position back into its releasing position by a spring (not shown). If, on the other hand, the latch 11 is moved significantly beyond the engaging point, it may be gripped and locked by the catch of the locking cylinder 15 described above, at the locking position located behind said engaging point.

As an alternative to the mechanical locking cylinder 15 according to FIG. 1, the closure 7 may comprise an electronic locking cylinder, for example having an electric motor (in particular a geared motor) for a rotary drive of a drive section and having a wirelessly transmitted code as an identification means.

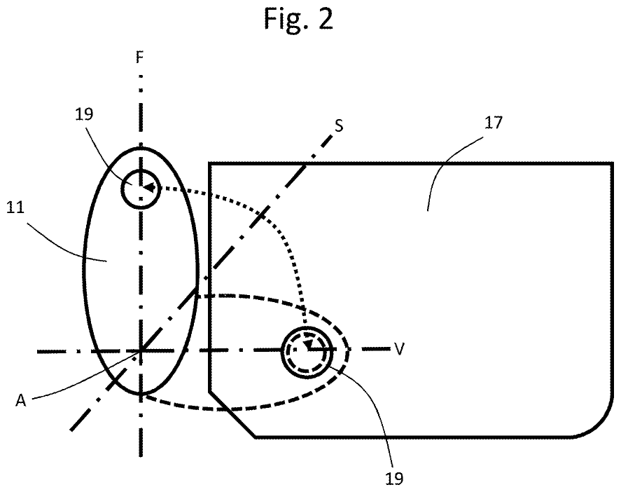

As an alternative to the linear movability of the latch 11 according to FIG. 1, the latch 11 may also be rotationally movable, i.e. according to a circular path along the actuation direction. Such an embodiment is illustrated in FIG. 2.

In the embodiment illustrated in FIG. 2, the latch 11 is rotatable from a releasing position F around an axis A into its securing position S and its locking position V, i.e. within the plane of representation. For a manual rotary actuation, the latch 11 may be connected to a rotary handle (not shown). In the releasing position F, the latch 11 is freely movable past a securing plate 17 in a direction perpendicular to the plane of the drawing, i.e. out of the plane of representation. Both in the securing position S and in the locking position V, the latch 11 engages behind the securing plate 17 which is mounted to the container or the lid. Both the latch 11 and the securing plate 17 each have a locking opening 19, which in the locking position V are in alignment. For locking, a corresponding catch (not shown), for example in the form of a pin, is moved through the two locking openings 19, in particular, perpendicular to the plane of representation. For example, such a catch may be driven and held by an axially actuated cylinder. Using the associated key, the catch, for example the pin, may then be moved out again at least from the locking opening 19 of the latch 11, in order to release the latch 11.

A more detailed description of such an axially actuated cylinder can be found, for example, in DE 10 2018 131 779 A1. As an alternative to a mechanical locking cylinder, the closure 7 may in turn have an electronic locking cylinder, for example having a solenoid for linear driving of a locking pin and having a wirelessly transmitted code as an identification means.

The container 3 (FIG. 1) may be formed to be substantially rigid, for example made of plastic or metal, or at least in areas to be flexible, for example made of a fabric.

The mounting device 4 is preferably configured for mounting the container 3 to the two-wheeler in a theft-proof manner. This means that the container 3 may only be removed non-destructively from the two-wheeler when the lid 5 is open and/or only with the aid of a tool or an identification means, for example in the form of the associated key or another key.

In preferred embodiments, the mounting device 4 comprises a holder that may, for example, have at least one bracket and/or at least one flat or angled tab. A bracket may be configured, for example, to engage around a frame section of the two-wheeler. A tab may be configured, for example, to cooperate with an associated counterpart of the two-wheeler (not shown), for example by hooking or engaging therewith. A theft-proof mounting of the container 3 to the two-wheeler, may take place, for example, by mounting means which may only be released through the use of tools, so that it is not possible for the container 3 to be quickly and inconspicuously removed from the two-wheeler. Preferably, the mounting means are only accessible from the storage space of the container 3.

In the embodiment shown in FIG. 1, the mounting means 4 comprises a locking mechanism having two locking pins 23 that cooperate with an associated counterpart of the two-wheeler (not shown). The locking pins 23 are operable only from the storage space of the container 3 in order to effect unlocking, wherein the locking pins 23 move along elongated pin openings 21. This may only be initiated by the authorized user, namely, when the lid 5 is in the open position and the storage space of the container 3 is thus accessible. Alternatively, a lock, for example, could also be provided so as to secure the container 3 to the two-wheeler, wherein the lock may be operable from the outside (by means of an associated identification means, for example, a key or said key for the locking cylinder 15).

What is claimed is:

1. A storage apparatus for mounting to a two-wheeler, the storage apparatus comprising:
a container having an opening which opens into a storage space of the container; and
a lid which is movable between an open position, in which the opening of the container is accessible, and a closed position, in which the opening of the container is closed;
wherein the storage apparatus comprises a closure which is configured to selectively occupy one of the following three states in the closed position of the lid:
a) a releasing state in which the closure releases the lid for movement to the open position;
b) a securing state in which the closure secures the lid in the closed position; and
c) a locking state in which the closure locks the lid in the closed position;
wherein an identification means is associated with the closure; and
wherein the closure is configured such that it may be brought from the securing state to the releasing state without using the associated identification means, but may only be brought from the locking state to the releasing state by using the associated identification means.

2. The storage apparatus according to claim 1, having a mounting device which is configured for mounting the container to the two-wheeler in a theft-proof manner such that the container may be removed non-destructively from the two-wheeler only when the lid is open and/or with the aid of a tool or an identification means.

3. The storage apparatus according to claim 2, wherein the mounting device comprises at least one of: a holder which is configured to cooperate with a counterpart of the two-wheeler; a flat or angled tab having a mounting opening through which a mounting means can be led; a locking mechanism which can only be unlocked from the storage space of the container; or a lock which is configured so as to secure the container to the two-wheeler.

4. The storage apparatus according to claim 1, wherein the closure comprises a locking cylinder which is oriented obliquely with respect to an extension plane of the lid.

5. The storage apparatus according claim 1, wherein the closure comprises a manually operable latch, and wherein the latch can be moved along an actuation direction selectively to a securing position in order to bring the closure into the securing state, or can be moved beyond the securing position to a locking position in order to bring the closure into the locking state.

6. The storage apparatus according to claim 5, wherein the closure comprises a locking cylinder which is configured such that, in a locked position, the locking cylinder locks the latch in the locking position or selectively, in an unlocked position, it releases the latch for movement from the locking position in the direction of the securing position, and wherein the locking cylinder may only be brought from the locked position into the unlocked position by using the associated identification means.

7. The storage apparatus according to claim 6, wherein the closure comprises a biased catch which is configured to automatically engage with the latch as a result of movement of the latch from the securing position to the locking position, in order to lock the latch in the locking position, and wherein the catch can be disengaged from the latch by moving the lock cylinder into the unlocked position.

8. The storage apparatus according to claim 6, wherein the closure comprises a catch which is configured to engage with the latch by manual actuation, in order to lock the latch in the locking position, and wherein the catch can be disengaged from the latch by moving the lock cylinder into the unlocked position.

9. A storage apparatus according to claim 1, wherein the latch is movable in a straight line along the actuation direction.

10. A storage apparatus according to claim 9, wherein the latch is operable in the manner of an ink cartridge of a retractable ballpoint pen.

11. The storage apparatus according to claim 1, wherein the latch is movable in accordance with a circular path along the actuation direction.

12. The storage apparatus according to claim 1, wherein the container is formed rigidly or at least partially flexible.

13. The storage apparatus according to claim 1, wherein the lid is pivotally mounted to the container between its open position and its closed position.

14. The storage apparatus according to claim 1, wherein the closure comprises a handle.

15. The storage apparatus according to claim 1 mounted to a two-wheeler having a front axle and a rear axle, on each of which at least one wheel is supported.

16. A storage apparatus for a two-wheeler, comprising:
a container having an opening which opens into a storage space of the container;
a lid which is movable between an open position, in which the opening of the container is accessible, and a closed position, in which the opening of the container is closed;
a closure; and
an identification means associated with the closure;
wherein the closure is configured to selectively adopt one of the following states in the closed position of the lid:
a) a releasing state in which the closure releases the lid for movement to the open position;
b) a securing state in which the closure secures the lid in the closed position without locking the lid; and
c) a locking state in which the closure locks the lid in the closed position;
wherein the closure can be brought from the securing state to the releasing state without using the associated identification means, but can only be brought from the locking state to the releasing state by using the associated identification means; and
wherein the closure comprises a manually operable latch, wherein the latch selectively can be moved from a releasing position along an actuation direction to a securing position and beyond the securing position to a locking position, wherein in the securing position of the latch the closure adopts the securing state, and wherein in the locking position of the latch the closure adopts the locking state.

17. The storage apparatus according to claim 16, wherein the closure comprises a locking cylinder which in a locked position locks the latch in the locking position and in an unlocked position releases the latch for movement from the locking position in the direction of the securing position; and
wherein the locking cylinder can be brought from the locked position into the unlocked position only by using the associated identification means.

18. The storage apparatus according to claim 17, wherein the closure comprises a movable catch which selectively engages with the latch in the locking position of the latch, wherein the catch can be disengaged from the latch only by moving the lock cylinder into the unlocked position.

19. The storage apparatus according to claim 16, wherein the associated identification means comprises a mechanical or electronic key.

20. A storage apparatus for a two-wheeler, comprising:
a container having an opening which opens into a storage space of the container;
a lid which is movable between an open position, in which the opening of the container is accessible, and a closed position, in which the opening of the container is closed;
a closure;
an identification means associated with the closure; and
a mounting device for mounting the container to the two-wheeler;
wherein the closure is configured to selectively adopt one of the following states in the closed position of the lid:
a) a releasing state in which the closure releases the lid for movement to the open position;
b) a securing state in which the closure secures the lid in the closed position without locking the lid; and
c) a locking state in which the closure locks the lid in the closed position;
wherein the closure can be brought from the securing state to the releasing state without using the associated identification means, but can only be brought from the locking state to the releasing state by using the associated identification means; and
wherein the mounting device is accessible for releasing the container from the two-wheeler only from the storage space in the open position of the lid.
